(19) United States
(12) Patent Application Publication
(10) Pub. No.: US 2017/0066627 A1
(43) Pub. Date: Mar. 9, 2017

(54) HOUSING ASSEMBLY FOR A SAFETY ACTUATION DEVICE

(71) Applicant: Otis Elevator Company, Farmington, CT (US)

(72) Inventors: Guohong Hu, Farmington, CT (US); Daryl J. Marvin, Farmington, CT (US)

(21) Appl. No.: 15/260,109

(22) Filed: Sep. 8, 2016

Related U.S. Application Data
(60) Provisional application No. 62/215,306, filed on Sep. 8, 2015.

(51) Int. Cl. B66B 5/02; B66B 11/02; B66B 9/00

(52) U.S. Cl. CPC B66B 5/02; B66B 9/00; B66B 11/02; B66B 5/044

(57) ABSTRACT

The present disclosure relates generally to housing assembly for a safety actuation device, the assembly including a mounting plate, a first channel wall and a second channel wall extending substantially perpendicular from the mounting plate, the first channel wall including a first channel wall interior surface, and the second channel wall including a second channel wall interior surface, wherein the first channel wall is positioned substantially parallel to the second channel wall to form a channel therebetween, and at least one guide device affixed to the first channel wall interior surface and the second channel wall interior surface.

### CROSS-REFERENCE TO RELATED APPLICATIONS

The present application is a nonprovisional patent application, which claims priority to 62/215,306, filed Sep. 8, 2015, and having the title of “HOUSING ASSEMBLY FOR A SAFETY ACTUATION DEVICE”, which is herein incorporated in its entirety.

### TECHNICAL FIELD OF THE DISCLOSED EMBODIMENTS

The present disclosure is generally related to elevator safety systems and, more specifically, a housing assembly for a safety actuation device.

### BACKGROUND OF THE DISCLOSED EMBODIMENTS

Some machines, such as an elevator system, include a safety system to stop the machine when it rotates or travels at excessive speeds in response to an inoperative component. Generally, traditional safety system components are attached to the car frame/support and are guided by the rails. During travel, there is a variation in the distance from the car frame to the rails. As such, the design of the power requirements for safety actuation has to account for the greatest distance variation, which leads to increased costs for the elevator system. There is therefore a need for a device to reduce the distance variation between the rail and the car frame.

### SUMMARY OF THE DISCLOSED EMBODIMENTS

In one aspect, a housing assembly for a safety actuation device is provided. The housing assembly includes a mounting plate, a first channel wall and a second channel wall extending substantially perpendicular from the mounting plate, the first channel wall including a first channel wall interior surface, and the second channel wall including a second channel wall interior surface, wherein the first channel wall is positioned substantially parallel to the second channel wall to form a channel therebetween, and at least one guide device affixed to the first channel wall interior surface and the second channel wall interior surface.

In an embodiment, each of the at least one guide devices affixed to the first channel wall interior surface is positioned adjacent to each of the at least one guide devices affixed to the second channel wall interior surface. In any of the preceding embodiments, the at least one guide device is removable. In any of the preceding embodiments, the at least one guide device comprises a guide pad.

In another aspect, a housing assembly for a safety actuation device is provided. The housing assembly includes, a mounting plate including a proximal end and a distal end, a first channel wall and a second channel wall extending substantially perpendicular from the mounting plate, wherein the first channel wall is positioned substantially parallel to the second channel wall to form a channel therebetween, and a flange extending from at least one of the proximal end and the distal end, the flange including a slot disposed therein, wherein the slot is substantially aligned with the channel.

In an embodiment, this housing assembly further includes at least one guide device affixed to the mounting plate. In an embodiment, this housing assembly the at least one guide device comprises a first roller and a second roller, wherein the first roller is located adjacent to the second roller to form a gap therebetween, wherein the gap is positioned substantially aligned with the channel and the slot.

In any embodiment of the housing assembly, the mounting plate includes at least one aperture disposed therein, the at least one aperture configured for mounting said assembly. In any embodiment of the housing assembly, the mounting plate includes at least one elevator accessory affixed thereto.

In one aspect, an elevator system is provided. The elevator system includes an elevator rail, an elevator car frame an elevator car affixed to the elevator car frame, the elevator car is configured to travel along the elevator rail, and a housing assembly for a safety actuation device affixed to the elevator car. The housing assembly includes a mounting plate, a first channel wall and a second channel wall extending substantially perpendicular from the mounting plate, the first channel wall including a first channel wall interior surface, and the second channel wall including a second channel wall interior surface, wherein the first channel wall is positioned substantially parallel to the second channel wall to form a channel therebetween, and at least one guide device affixed to the first channel wall interior surface and the second channel wall interior surface; wherein the elevator rail is disposed within the channel.

In any embodiment of the elevator system, each of the at least one guide devices affixed to the first channel wall interior surface is positioned adjacent to each of the at least one guide devices affixed to the second channel wall interior surface. In any embodiment of the elevator system, the at least one guide device is removable. In any embodiment of the elevator system, the at least one guide device comprises a guide pad.

In one aspect, an elevator system is provided. The elevator system includes an elevator rail, an elevator car frame, an elevator car affixed to the elevator car frame, the elevator car is configured to travel along the elevator rail, and a housing assembly for a safety actuation device affixed to the elevator car. The housing assembly includes a mounting plate including a proximal end and a distal end, a first channel wall and a second channel wall extending substantially perpendicular from the mounting plate, wherein the first channel wall is positioned substantially parallel to the second channel wall to form a channel therebetween, and a flange extending from at least one of the proximal end and the distal end, the flange including a slot disposed therein, wherein the slot is substantially aligned with the channel.

An embodiment of this elevator system further includes at least one guide device affixed to the mounting plate. In an embodiment of this elevator system, the at least one guide device includes a first roller and a second roller, wherein the first roller is located adjacent to the second roller to form a gap therebetween, wherein the gap is positioned substantially aligned with the channel and the slot.

An embodiment of this elevator system further includes at least one aperture disposed within the mounting plate, the at least one aperture configured for mounting said assembly. An embodiment of this elevator system further includes at least one elevator accessory affixed to the mounting plate.

Other embodiments are also disclosed.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic diagram of an elevator system employing a mechanical governor;

FIG. 2 is a front view of a safety actuation housing assembly according to an embodiment of the present disclosure;

FIG. 3 is a top view of a safety actuation housing assembly according to an embodiment of the present disclosure;

FIG. 4 is a front view of a safety actuation housing assembly according to another embodiment of the present disclosure; and

FIG. 5 is a top view of a safety actuation housing assembly according to another embodiment of the present disclosure.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

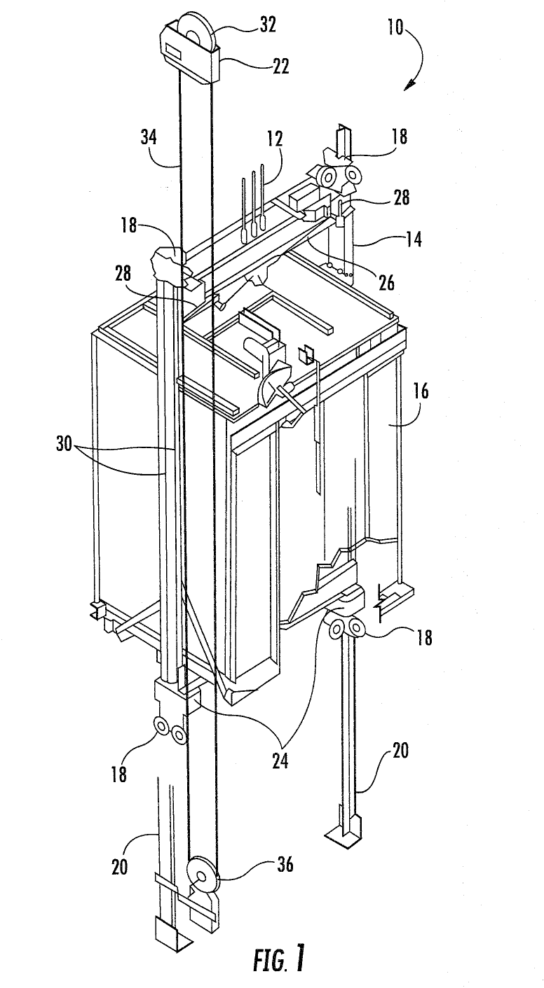

FIG. 1 shows an elevator system, generally indicated at 10. The elevator system 10 includes cables 12, a car frame 14, a car 16, roller guides 18, guide rails 20, a governor 22, safeties 24, linkages 26, levers 28, and lift rods 30. Governor 22 includes a governor sheave 32, rope loop 34, and a tensioning sheave 36. Cables 12 are connected to car frame 14 and a counterweight (not shown in FIG. 1) inside a hoistway. Car 16, which is attached to car frame 14, moves up and down the hoistway by force transmitted through cables 12 to car frame 14 by an elevator drive (not shown) commonly located in a machine room at the top of the hoistway. Roller guides 18 are attached to car frame 14 to guide the car 16 up and down the hoistway along guide rail 20. Governor sheave 32 is mounted at an upper end of the hoistway. Rope loop 34 is wrapped partially around governor sheave 32 and partially around tensioning sheave 36 (located in this embodiment at a bottom end of the hoistway). Rope loop 34 is also connected to elevator car 16 at lever 28, ensuring that the angular velocity of governor sheave 32 is directly related to the speed of elevator car 16

In the elevator system 10 shown in FIG. 1, governor 22, an electromechanical brake (not shown) located in the machine room, and safeties 24 act to stop elevator car 16 if car 16 exceeds a set speed as it travels inside the hoistway. If car 16 reaches an over-speed condition, governor 22 is triggered initially to engage a switch, which in turn cuts power to the elevator drive and drops the brake to arrest movement of the drive sheave and thereby arrest movement of car 16. If, however, cables 12 break or car 16 otherwise experiences a free-fall condition unaffected by the brake, governor 22 may then act to trigger safeties 24 to arrest movement of car 16. In addition to engaging a switch to drop the brake, governor 22 also releases a clutching device that grips the governor rope 34. Governor rope 34 is connected to safeties 24 through mechanical linkages 26, levers 28, and lift rods 30. As car 16 continues its descent unaffected by the brake, governor rope 34, which is now prevented from moving by actuated governor 22, pulls on operating lever 28. Operating lever 28 “sets” safeties 24 by moving linkages 26 connected to lift rods 30, which lift rods 30 cause safeties 24 to engage guide rails 20 to bring car 16 to a stop.

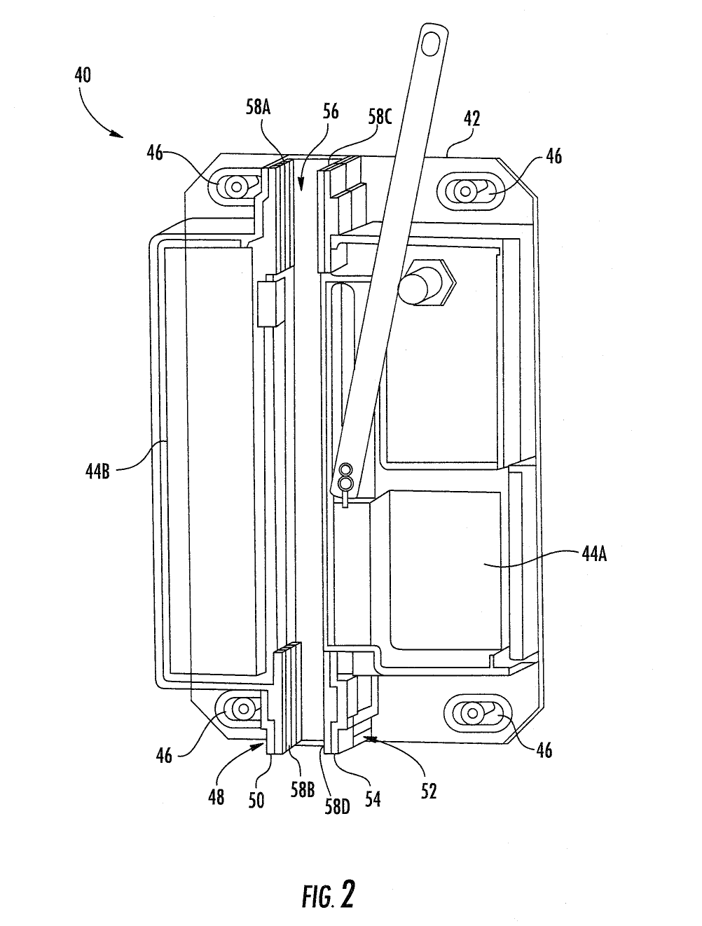

FIG. 2 shows an embodiment of a housing assembly for a safety actuation device 40 configured to be affixed to the car frame 14. The housing assembly 40 includes a mounting plate 42. In one embodiment, the assembly 40 includes at least one elevator accessory 44 affixed to the mounting plate 42. It will be appreciated that the at least one elevator accessory may include a safety actuation device, and one or more sensors to name a couple of non-limiting examples.

In an embodiment, the mounting plate 42 includes at least one aperture 46 disposed therein for mounting the assembly 40 to the car frame 14. The apertures 46 on the mounting plate 42 and the fasteners fixed on the car frame 14 allow a safety actuation device 44A to be floating horizontally when there is position variation between the car 16 and the rail 20, which typically occurs during actuating and resetting the safeties 24, as well as an elevator normal run.

The assembly 40 further includes a first channel wall 48 including a first channel wall interior surface 50, and a second channel wall 52 including a second channel wall interior surface 54. The first channel wall 48 and the second channel wall 52 extend substantially perpendicular from the mounting plate 42, and the first guide wall 48 is positioned substantially parallel to the second guide wall 52 to form a channel 56 therebetween.

The assembly 40 further includes at least one guide device 58 configured to engage a component disposed within the channel 56. In an embodiment, the at least one guide device 58 includes at least one guide pad 58 affixed to the first channel wall interior surface 50 and the second channel wall interior surface 54.

In some embodiments, each of the at least one guide pads 58 is affixed to the first channel wall interior surface 50 and positioned adjacent to each of the at least one guide pads 58 affixed to the second channel wall interior surface 54. For example, in the embodiment shown, the guide pads 58A and 58B are disposed on the first channel wall interior surface 50 towards the ends, and the guide pads 58C and 58D are positioned along the second channel wall interior surface 54 substantially adjacent to the guide pads 58A and 58B, respectively. It will be appreciated that the guide pads 58 may also be formed from one piece of material and adjusted to accommodate for the elevator accessories 44.

In another embodiment, the at least one guide pads 58 are removable for replacement and service purposes. It will be appreciated that the at least one guide pads 58 may be composed of a high weight, wear resistant plastic to name one non-limiting example.

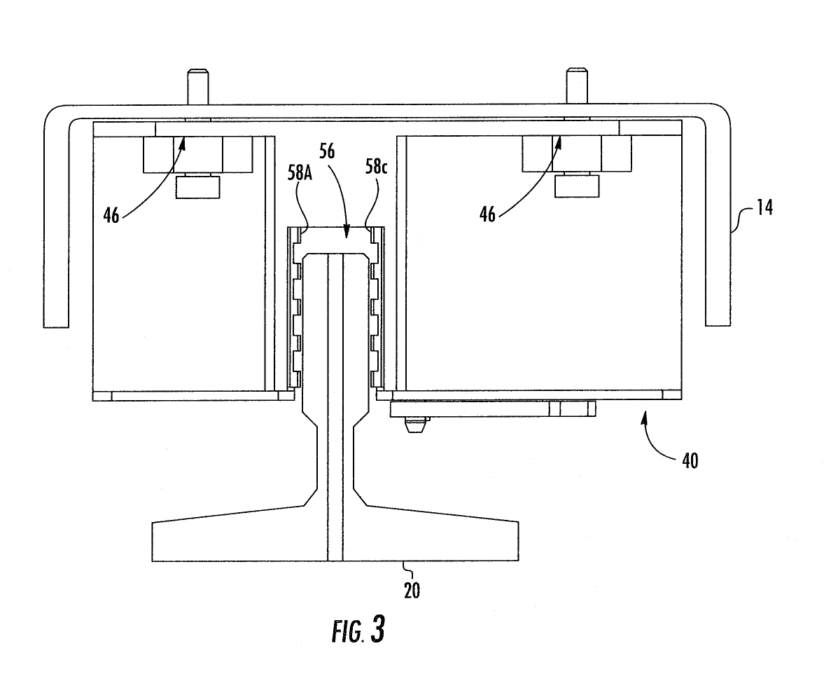

As shown in FIG. 3, the rail 20 is disposed with the channel 56. The at least one guide pads 58A and 58C may or may not be in contact with the rail 20 to minimize the impact of position variations between the car 16 and the rail 20. Moreover, the at least one guide pads 58A and 58C are capable of preventing small objects from entering the channel 56 to obstruct the safety actuator 44A.

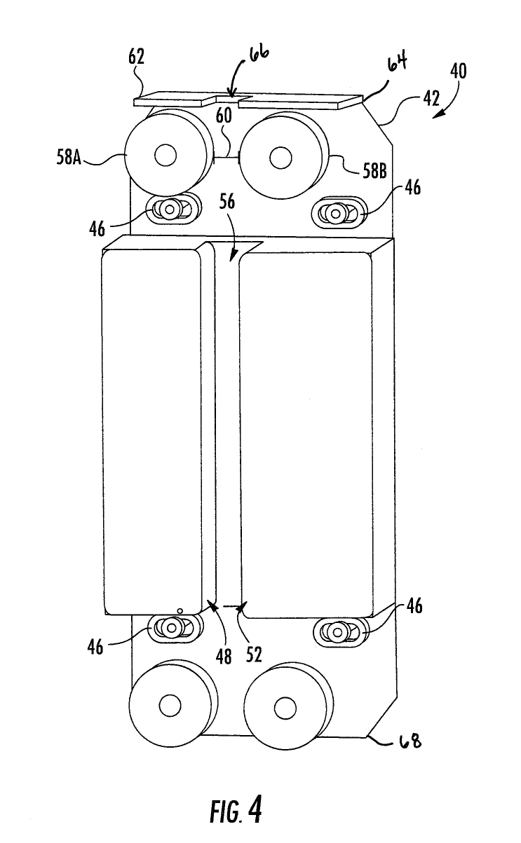

In another embodiment, as shown in FIG. 4, the mounting plate 42 includes a flange 62 extending from a proximate end 64 of the mounting plate 42. The flange 62 includes a slot 66 disposed in the flange 62, wherein the slot 66 is substantially aligned with the channel 56. The flange 62 is configured to prevent small objects from entering the channel 56 to obstruct the safety actuator 44A. It will be appreciated that the flange 62 may extend from the proximate end 64, a distal end 68 of the mounting plate 42, or both.

In the embodiment shown in FIG. 4, the assembly 40 further includes at least one guide device 58 affixed to the mounting plate 42. In this embodiment, the at least one guide device includes a first roller 58A and a second roller 58B affixed to the mounting plate 42. The first roller 58A is located adjacent to the second roller 58B to form a gap 60 therebetween, wherein the gap 60 is substantially aligned with the channel 56 and the slot 66. In another embodiment, the first roller 58A and a second roller 58B are removable for replacement and service purposes. It will be appreciated that the first roller 58A and the second roller 58B may be positioned above and/or below the first channel wall 48 and the second channel wall 52

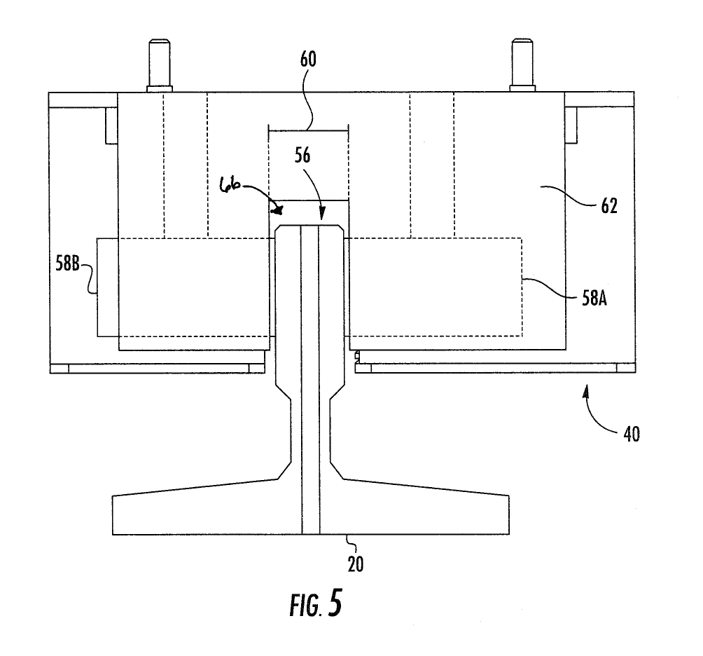

As shown in FIG. 5, the rail 20 is disposed with the channel 56, the slot 66, and the gap 60. The first roller 58A and the second roller 58B are engaged with the rail 20 to minimize the impact of position variations between the car 16 and the rail 20.

It will therefore be appreciated that the present embodiments include a mounting assembly 40 having at least one guide device 58 disposed within channel 56, or alternatively at least one guide device 58 affixed to the mounting plate 42 to form gap 60 substantially aligned with the channel 56 to improve the performance of safety actuation and reset due to the minimized position variations between the car 16 and the rail 20. As a result, the power requirements for safety actuation is reduced, and effectively reducing the cost of the elevator system 10.

While the disclosure has been illustrated and described in detail in the drawings and foregoing description, the same is to be considered as illustrative and not restrictive in character, it being understood that only certain embodiments have been shown and described and that all changes and modifications that come within the spirit of the disclosure are desired to be protected.

What is claimed is:

1. A housing assembly for a safety actuation device comprising:
a mounting plate;
a first channel wall and a second channel wall extending substantially perpendicular from the mounting plate, the first channel wall including a first channel wall interior surface, and the second channel wall including a second channel wall interior surface, wherein the first channel wall is positioned substantially parallel to the second channel wall to form a channel therebetween; and
at least one guide device affixed to the first channel wall interior surface and the second channel wall interior surface.

2. The assembly of claim 1, wherein each of the at least one guide devices affixed to the first channel wall interior surface is positioned adjacent to each of the at least one guide devices affixed to the second channel wall interior surface.

3. The assembly of claim 1, wherein the at least one guide device is removable.

4. The assembly of claim 1, wherein the at least one guide device comprises a guide pad.

5. A housing assembly for a safety actuation device comprising:
a mounting plate including a proximal end and a distal end;
a first channel wall and a second channel wall extending substantially perpendicular from the mounting plate, wherein the first channel wall is positioned substantially parallel to the second channel wall to form a channel therebetween; and
a flange extending from at least one of the proximal end and the distal end, the flange including a slot disposed therein, wherein the slot is substantially aligned with the channel.

6. The assembly of claim 5, further comprising at least one guide device affixed to the mounting plate.

7. The assembly of claim 6, wherein the at least one guide device comprises a first roller and a second roller, wherein the first roller is located adjacent to the second roller to form a gap therebetween, wherein the gap is positioned substantially aligned with the channel and the slot.

8. The assembly of claim 5, further comprising at least one aperture disposed within the mounting plate, the at least one aperture configured for mounting said assembly.

9. The assembly of claim 5, further comprising at least one elevator accessory affixed to the mounting plate.

10. An elevator system comprising:
an elevator rail;
an elevator car frame;
an elevator car affixed to the elevator car frame, the elevator car is configured to travel along the elevator rail; and
a housing assembly for a safety actuation device affixed to the elevator car, the housing assembly comprising:
a mounting plate;
a first channel wall and a second channel wall extending substantially perpendicular from the mounting plate, the first channel wall including a first channel wall interior surface, and the second channel wall including a second channel wall interior surface, wherein the first channel wall is positioned substantially parallel to the second channel wall to form a channel therebetween; and
at least one guide device affixed to the first channel wall interior surface and the second channel wall interior surface;
wherein the elevator rail is disposed within the channel.

11. The elevator system of claim 10, wherein each of the at least one guide devices affixed to the first channel wall interior surface is positioned adjacent to each of the at least one guide devices affixed to the second channel wall interior surface.

12. The elevator system of claim 10, wherein the at least one guide device is removable.

13. The elevator system of claim 10, wherein the at least one guide device comprises a guide pad.

14. An elevator system comprising:
an elevator rail;
an elevator car frame;
an elevator car affixed to the elevator car frame, the elevator car is configured to travel along the elevator rail; and
a housing assembly for a safety actuation device affixed to the elevator car, the housing assembly comprising:
a mounting plate including a proximal end and a distal end;
a first channel wall and a second channel wall extending substantially perpendicular from the mounting plate, wherein the first channel wall is positioned substantially parallel to the second channel wall to form a channel therebetween; and
a flange extending from at least one of the proximal end and the distal end, the flange including a slot disposed therein, wherein the slot is substantially aligned with the channel.

15. The elevator system of claim 14, further comprising at least one guide device affixed to the mounting plate.

16. The elevator system of claim 15, wherein the at least one guide device comprises a first roller and a second roller, wherein the first roller is located adjacent to the second roller to form a gap therebetween, wherein the gap is positioned substantially aligned with the channel and the slot.

17. The elevator system of claim 10, further comprising at least one aperture disposed within the mounting plate, the at least one aperture configured for mounting said assembly.

18. The elevator system of claim 10, further comprising at least one elevator accessory affixed to the mounting plate.
